(19) United States
(12) Patent Application Publication
(10) Pub. No.: US 2007/0094598 A1
(43) Pub. Date: Apr. 26, 2007

(54) Image forming apparatus

(75) Inventors: Yasuhiro Nakai, Kyoto (JP); Masao Saeda, Nara (JP); Haruo Kawauchi, Nara (JP)

Correspondence Address: EDWARDS & ANGELL, LLP, P.O. BOX 55874, BOSTON, MA, 02205, US

(73) Assignee: Sharp Kabushiki Kaisha, Osaka (JP)

(21) Appl. No.: 11/581,957

(22) Filed: Oct. 16, 2006

(30) Foreign Application Priority Data
Oct. 17, 2005 (JP) 2005-301767

(51) Int. Cl. G06F 17/00

(52) U.S. Cl. 715/703; 345/619

(57) ABSTRACT

The image forming apparatus includes a display portion that displays switchably at least two different operation screens, a timer that measures a time, an apparatus control portion that controls switching to one of the at least two different operation screens depending on the time, and a management portion that accumulates a first program for displaying the one operation screen and a second program for displaying the other operation screen. The apparatus control portion reads and executes either the first program or the second program depending on the time from the timer.

This Nonprovisional application claims priority under 35 U.S.C. §119(a) on Patent Application No. 2005-301767 filed in JAPAN on Oct. 17, 2005, the entire contents of which are hereby incorporated herein by references.

### FIELD OF THE INVENTION

The present invention relates to an image forming apparatus, and more particularly, to an image forming apparatus having a function to display its operation screens switchably depending on time (time zone).

### BACKGROUND OF THE INVENTION

Image forming apparatuses such as digital multi-function peripherals (MFP) have hitherto been disposed in shops, etc., to provide printing service or other various services to common customers. In case of using the image forming apparatuses for business use, as display contents are different between the screen for printing service and the screen for business use, the operation screen needs to be changed each time.

In case of disposing the image forming apparatuses for use in shops, etc., it may be conceivable that their forms of use are changed depending on the time zone in such a manner that they are used as self-copiers for common customers in the daytime, while being used for business use in the nighttime after closing the shops. In such a case, the operation screens need to be switched depending on the time zone to facilitate use of users. In the above example, the operations require a lot of time and effort since the person in charge of system has to change the setting each time such that the printing service operation screen is set in the daytime while the business-use operation screen is set in the nighttime.

On the contrary, some image forming apparatuses are equipped with a function to customize the operation screen. For example, Japanese Laid-Open Patent Publication No. 09-114627 discloses an image forming apparatus arranged to enable display colors of specific operation screens and of specific buttons or specific characters to be changed for each user. This enables the designs of the operation screens (including the display colors of the buttons or characters) to be changed (customized) depending on the users, achieving an improved operability.

However, the above conventional image forming apparatus is not configured to change the operation screen depending on the time (time zone), and hence, if a single image forming apparatus is to be used in different forms (such as the printing service mode and business-use mode), there is a need to change the setting each time, imposing a heavy burden on the user managing the image forming apparatus.

In this manner, the conventional image forming apparatuses such as digital multi-function peripherals require a change of settings to switch from their basic operation screens to other operation screens, which takes a lot of time and effort. Some have functions to customize the operation screens, but they involve the problem of heavy burden for common users to master such customizing features.

### SUMMARY OF THE INVENTION

An object of the present invention is to enable an image forming apparatus that forms images from input image data to display switchingly at least two different operation screens depending on the time (time zone).

Another object of the present invention is to provide an image forming apparatus forming images from image data entered, comprising a display portion that displays switchably at least two different operation screens, a timer that measures a time, and a control portion that controls switching to one of the at least two different operation screens depending on the time.

Another object of the present invention is to provide an image forming apparatus, wherein the at least two different operation screens are respectively set for corresponding modes that depend on forms of use of the image forming apparatus so that functions corresponding to the modes are respectively assigned to the at least two different operation screens.

Another object of the present invention is to provide an image forming apparatus accumulating a first program for displaying one of the at least two different operation screens, and a second program for displaying the other thereof, wherein the control portion reads either the first program or the second program for execution depending on the time.

Another object of the present invention is to provide an image forming apparatus, wherein the functions include one or more of a copier function, a printer function, a scanner function, and a facsimile function.

Another object of the present invention is to provide an image forming apparatus, wherein the modes include a printing service mode for providing printing services to charge for the services, and a business-use mode for use in general business.

Another object of the present invention is to provide an image forming apparatus, wherein the operation screen is comprised of a touch panel capable of entering coordinate positions of input regions on the operation screen.

Another object of the present invention is to provide an image forming apparatus, wherein the at least two different operation screens and the time zones to display the operation screens are set in an associated manner, and wherein the control portion switches to one of the at least two different operation screens depending on the settings.

### BRIEF DESCRIPTION OF THE DRAWINGS.

FIG. 1 is a block diagram of a schematic configuration example of an image forming apparatus according to an embodiment of the present invention.

FIG. 2 depicts a configuration example of a system including a digital multi-function peripheral and an accounting device that are connected to each other.

FIG. 3 depicts a configuration example of an operation portion included in the digital multi-function peripheral.

FIG. 4 depicts an example of a user setting screen displayed on a touch panel of the digital multi-function peripheral.

FIG. 5 depicts an example of an authentication information input screen for allowing a key operator program setting screen to appear on the touch panel of the digital multi-function peripheral.

FIG. 6 depicts another example of the authentication information input screen.

FIG. 7 depicts an example of a key operator program screen appearing on the touch panel of the digital multi-function peripheral.

FIG. 8 depicts an example of a time management screen appearing on the touch panel of the digital multi-function peripheral.

FIG. 9 depicts an example of a schedule setting screen appearing on the touch panel of the digital multi-function peripheral.

FIG. 10A depicts an example of a time setting screen appearing on the touch panel of the digital multi-function peripheral.

FIG. 10B depicts an example of a program setting screen appearing on the touch panel of the digital multi-function peripheral.

FIGS. 11A and 11B depict examples of an operation screen appearing on the touch panel of the digital multi-function peripheral.

FIG. 12 is a flow diagram for explaining the flow of operation screen switching display processing effected by the digital multi-function peripheral of the present invention.

### PREFERRED EMBODIMENTS OF THE INVENTION

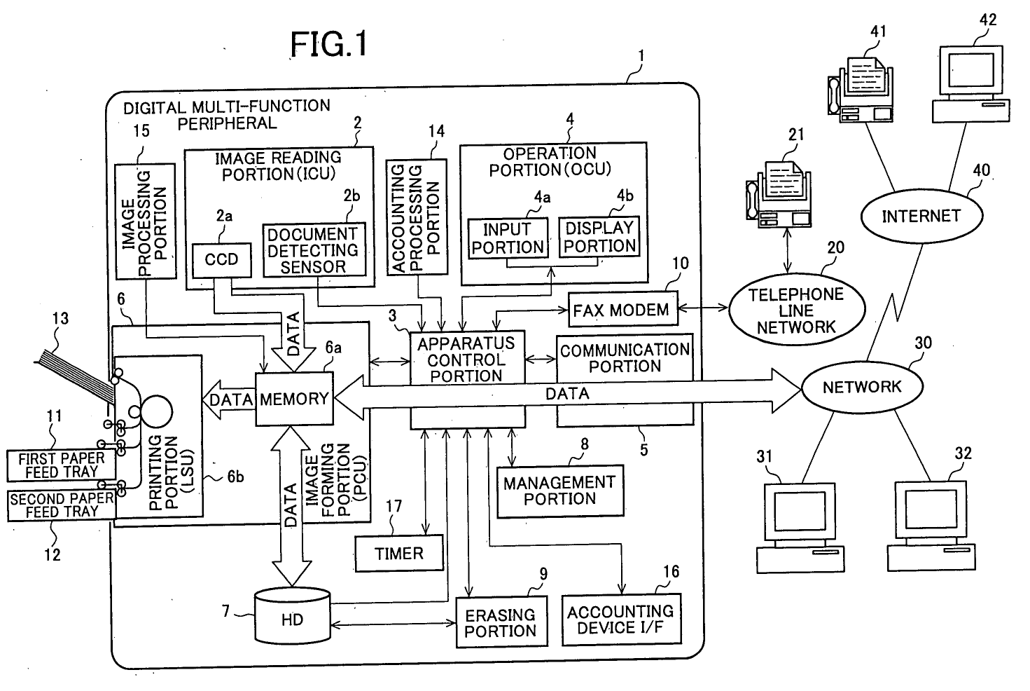

FIG. 1 is a block diagram of a schematic configuration example of an image forming apparatus according to an embodiment of the present invention. Referring to FIG. 1, reference numeral 1 denotes an image forming apparatus, 20 denotes a telephone line network, 30 denotes a communication network in the form of a LAN, etc., 21 denotes a facsimile device connected to the telephone line network 20, reference numerals 31 and 32 denote terminal devices such as personal computers (PCs) connected to the communication network 30, reference numeral 40 denotes an internet serving as a wide-area communication network, 41 denotes a facsimile device connected to the internet 40, and reference numeral 42 denotes a terminal device such as a PC connected to the internet 40. The image forming apparatus 1 enables transmission/reception of image data or document data by FAX between the facsimile devices 21 and 41, and enables transmission/reception of image data or document data using electronic mails, etc., between the terminal devices 31, 32, and 42.

The image forming apparatus 1 of this embodiment will hereinafter be described as a digital multi-function peripheral 1 that is a representative example of the image forming apparatus 1 having any two or more functions of scanner function, copier function, facsimile function, and printer function.

Referring to FIG. 1, the digital multi-function peripheral 1 includes an image control unit (ICU) 2 acting as an image reading portion that reads a document to enter image data, an apparatus control portion 3 that controls functions of the digital multi-function peripheral 1, an operation control unit (OCU) 4 acting as an operation portion that accepts a user input, a communication portion 5 that communicates with the terminal devices 31 and 32 via the communication network 30 such as a LAN and that communicates with the facsimile device 41 and the terminal device 42 via the internet 40, a process control unit (PCU) 6 acting as an image forming portion that performs image data print processing, a hard disk (HD) 7 for storing image data, etc., a management portion 8 that is a memory storing control information and setting information on the digital multi-function peripheral 1, an erasing portion 9 that erases image data stored in the HD 7, and a FAX modem 10 for communicating with the facsimile device 21 via the telephone line network 20.

The digital multi-function peripheral 1 includes a first paper feed tray 11, a second paper feed tray 12, and a paper discharge tray 13. The first 11 and the second 12 paper feed trays are fitted removably to the digital multi-function peripheral 1 to feed paper for image formation to the image forming portion 6. The paper discharge tray 13 receives paper fed from the first 11 or the second 12 paper feed tray and having images formed thereon by the image forming portion 6.

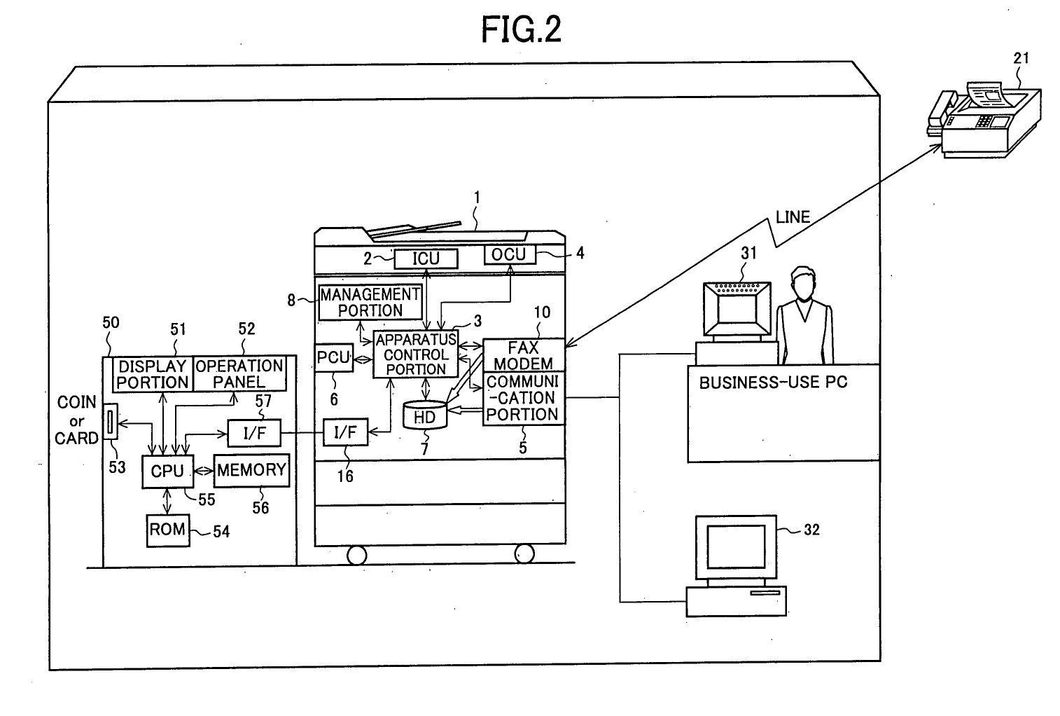

The digital multi-function peripheral 1 further includes an accounting processing portion 14, an image processing portion 15, an accounting device interface (accounting device I/F) 16, and a timer 17. The accounting device I/F 16 is an interface that connects to an accounting device (shown in FIG. 2 described later) for charging for printing services provided by the digital multi-function peripheral 1.

The accounting processing portion 14 is connected to the apparatus control portion 3 and performs e.g., setting of charge for the above accounting processing. The apparatus control portion 3 controls the accounting device to charge by the number of copies when e.g., 10 yen per copy is set by the accounting processing portion 14. The accounting device can be of a coin type or a card (prepaid card, etc.) type. The image processing portion 15 subjects image data entered in the image forming portion 6 to various image processings. The timer 17 is connected to the apparatus control portion 3 and serves as a means such as a clock that measures time (including the date and time, etc)

Detailed description will now be made of the units of the digital multi-function peripheral 1 shown in FIG. 1.

The digital multi-function peripheral 1 has the apparatus control portion 3 that includes a CPU performing calculations and a RAM storing temporary information attendant on the calculations. The apparatus control portion 3 includes a ROM storing a control program for control of the digital multi-function peripheral 1. The apparatus control portion 3 connects to the management portion 8 in the form of a memory storing management information (various pieces of control information) for management of processings effected by the digital multi-function peripheral 1.

The apparatus control portion 3 connects to the image reading portion 2 that reads images recorded on a document to create image data. The image reading portion 2 includes a CCD (Charge Coupled Device) 2a for capturing document images as image data, and a document detecting sensor 2b that detects whether a document is present on a document table, an automatic document feeder (ADF), etc.

The apparatus control portion 3 connects to the image forming portion 6 in the form of the process control unit (PCU) that forms image data on recording paper. The image forming portion 6 includes a memory 6a temporarily storing image data, a laser scanning unit (LSU) 6b acting as a printing portion that forms images from image data stored in the memory 6a and that records the thus formed images on recording paper, the first 11 and the second 12 paper feed trays that are trays for feeding paper for forming images thereon by the printing portion 6b, and the paper discharge tray 13 that is a tray for ejecting paper.

The apparatus control portion 3 connects to the FAX modem 10 for facsimile communication, which in turn is connected to the telephone line network 20. By facsimile communication, the digital multi-function peripheral 1 is capable of transmitting image data created by the image reading portion 2, via the telephone line network 20 connected to the FAX modem 10, to the other facsimile device 21. The digital multi-function peripheral 1 is capable of receiving image data transmitted via the telephone line network 20 from the other facsimile device 21 by the FAX modem 10, to form images from the thus received image data by the image forming portion 6.

The apparatus control portion 3 connects to the communication portion 5 for allowing the digital multi-function peripheral 1 to transmit/receive information to/from the exterior. The communication portion 5 is connectable to the communication network 30 such as an in-house LAN, to which is connectable the terminal devices 31 and 32 such as one or more personal computers (PCs). In the ordinary state where the digital multi-function peripheral 1 operates singly, the communication portion 5 is connected to the communication network 30 so as to interchange information with the terminal devices 31 and 32 via the communication network 30.

The digital multi-function peripheral 1 is capable of transmitting image data created by the image reading portion 2 from the communication portion 5 to the terminal devices 31 and 32. The digital multi-function peripheral 1 is capable of receiving image data transmitted from the terminal devices 31 and 32 by the communication portion 5 and of forming images from the received image data by the image forming portion 6.

The communication network 30 is connected further to the internet 40 that is a wide-area communication network. By using e.g., a manner of transmitting electronic mail having image data attached thereto, the communication portion 5 is capable of receiving-image data via the communication network 30 and the internet 40 from the facsimile device 41 and the external terminal device 42 that are connected to the internet 40.

The apparatus control portion 3 connects to the operation portion 4 that accepts an operation from a user. The operation portion 4 includes an input portion 4a in the form of a touch panel, a numeric keypad, etc., to which information such as a control instruction is entered by the user's operation, and a display portion 4b in the form of a liquid crystal panel that displays information necessary for the operation. An authentication code is entered into the operation portion 4 for authenticating the user or the operator of the image forming apparatus. The authentication code may be entered from an external device via the FAX modem 10 or the communication portion 5.

The apparatus control portion 3 connects to the hard disk (HD) 7. The HD 7 stores image data relating to image processing for image data, etc., created by the image reading portion 2. The apparatus control portion 3 connects to the erasing portion 9. The erasing portion 9 erases data stored and held on the HD 7 in accordance with control provided by the apparatus control portion 3.

Brief description will hereinafter be made of operation examples relating to image processing modes provided by the digital multi-function peripheral 1.

(Copy Mode)

In case of using the digital multi-function peripheral 1 according to the embodiment as a copier, image data of a document read by the image reading portion 2 is outputted as a copy from the image forming portion 6.

The image reading portion 2 is provided with the CCD 2a so that an image of a document disposed at a reading position can electronically be read. The read image data of the document is then completed as output data on the memory 6a, and temporarily stored on the HD 7. When a plurality of documents are present, these operations of reading and storing are repeated. Afterward, based on a processing mode specified from the operation portion 4, the image data stored on the HD 7 is successively read at proper timing to be sent to the memory 6a. In unison with the timing of writing into the printing portion 6b, the image data is transferred from the memory 6a to the printing portion 6b.

Also in case of printing a plurality of copies from the read image data, the image data is stored similarly as output data on the HD 7 on a page-to-page basis, and is sent from the HD 7 to the memory 6a in conformity with the outputting mode. These operations are repeated by the number of outputted copies, after which the image data is transferred to the printing portion 6b in unison with the timing of writing into the printing portion 6b.

(Printer Mode)

In case of using the digital multi-function peripheral 1 according to the embodiment as a printer, image data received from the communication portion 5 is outputted via the memory 6a, etc., from the image forming portion 6.

The communication portion 5 is connected to the communication network 30 by utilizing cable or radio and receives image data from the terminal devices 31 and 32 that are external devices connected on the communication network 30. The thus received image data is sent as output image data on a page-to-page basis to the memory 6a and is temporarily stored on the HD 7. The image data is again sent from the HD 7 to the memory 6a to be transferred to the printing portion 6b in the same manner as the case of using as the copier.

(Scanner Mode)

In case of using the digital multi-function peripheral 1 according to the embodiment as a network scanner, image data of a document read by the image reading portion 2 can be transmitted from the communication portion 5 via the communication network 30 to the terminal devices 31 and 32. In this case as well, the document is electronically read by the CCD 2a of the image reading portion 2. The thus read document image data is then completed as output data on the memory 6a and is temporarily stored on the HD 7. The image data is again sent from the HD 7 to the memory 6a and, after establishing a communication with a sending destination specified via the operation portion 4, is transmitted from the communication portion 5 to the sending destination.

(Facsimile Mode)

The communication portion 5 is further connected to the facsimile device 41 by way of the communication network 30 and the internet 40. The FAX modem 10 may connect to the facsimile device 21 by way of the telephone line network 20. Similar operations are performed also in case of using the digital multi-function peripheral 1 according to the embodiment as a facsimile device, enabling image data to be transmitted to and received from the external devices.

The apparatus control portion 3 controls the units making up the digital multi-function peripheral 1, monitors operation instructions from the input portion 4a such as a tablet or keys provided in the operation portion 4, and provides appropriate guidance and display of information such as information on the status of the digital multi-function peripheral 1 to be given to the user via the display portion 4b. The management portion 8 manages information on the constituent units controlled by the apparatus control portion 3 and, based on such information, controls the operations of the entire digital multi-function peripheral 1.

The digital multi-function peripheral 1 of the present invention aims chiefly to display switchingly at least two different operation screens depending on the time (time zone), and therefore is configured to include the display portion 4b that displays two operation screens in a switchable manner, the timer 17 that measures the time, and the apparatus control portion 3 that provides a control to switch to one of the two operation screens depending on the time. It is to be noted that the two operation screens are set for each mode depending on the form of use of the digital multi-function peripheral 1 and that it has functions assigned correspondingly to the modes.

The number of switchable operation screens is not limited to two but three or more switchable operation screens may be set depending on the number of modes. As used herein, the term “function” refers to e.g., one or more functions of copier function, printer function, scanner function and facsimile function, and may cover, e.g., individual functions (double-sided copying function, finishing function, etc.) included in the copier function. The term “mode” is intended to include e.g., the printing service mode for providing printing service to charge therefor, and the business-use mode for use in general business. The printing service mode is intended to include copying service mode for providing copying service.

The management portion 8 has accumulatively a printing service program for displaying an operation screen to which the printing service function is assigned, and a business-use program for displaying an operation screen to which the business-use function is assigned. Depending on the time provided by the timer 17, the apparatus control portion 3 reads for execution either the printing service program or the business-use program from the management portion 8.

For example, in case of disposing and using the digital multi-function peripheral 1 in a shop, etc., control is provided such that it functions as a self copier for common users executing the printing service program during the time zone of daytime (e.g., 09:00 to 18:00 hours) and that it functions as a business-use copier executing the business-use program during the time zone of nighttime (e.g., 18:00 to 09:00 hours on the next day) after closure of the shop, thereby switching the operation screens depending on the time zone. When e.g., 09:00 hours arrive during displaying the business-use operation screen as a result of execution of the business-use program, the apparatus control portion 3 automatically executes the printing service program to switch the screen of the display 4b to the printing service operation screen. It is to be noted that, when the power of the digital multi-function peripheral 1 is turned on from off state, the timer 17 measures the time at that time, based on which result the apparatus control portion 3 reads a either program for execution.

FIG. 2 depicts a configuration example of a system including the digital multi-function peripheral 1 and the accounting device that are connected to each other. The digital multi-function peripheral 1 is connected to the accounting device 50 for charging for copy processing effected by the digital multi-function peripheral 1. The accounting device 50 includes a display portion 51 for displaying accounting information, an operation panel 52 for entering a user operation, a slot portion 53 for receiving a coin or a prepaid card, a ROM 54 storing a control program, etc., a CPU 55 controlling the entire accounting device 50, a memory 56 that is an area to execute the control program, and an I/F 57 for connection to the digital multi-function peripheral 1.

The I/F 16 of the digital multi-function peripheral 1 is connected to the I/F 57 of the accounting device 50 so that the apparatus control portion 3 of the digital multi-function peripheral 1 provides a control of accounting processing effected by the accounting device 50. Assume herein that the accounting processing portion 14 sets 10 yen per A4 black-and-white copy. The user inserts 200 yen in advance through the slot portion 53 of the accounting device 50. In accordance with the user operation, the digital multi-function peripheral 1 executes copying from a document to recording paper to create ten A4 black-and-white copies. The copy charge at that time is calculated at the number 10 of copies×10 yen/copy=100 yen by the accounting processing portion 14, with the result that the apparatus control portion 3 instructs the accounting device 50 to subtract the 100 yen. In compliance with the instruction from the apparatus control portion 3, the accounting device 50 performs processing to subtract “100 yen” from “200 yen” that is the inserted amount of money to return the remainder.

The accounting processing portion 14 may set the copy charge depending on e.g., the number of copies, the type of copy (such as color or black-and-white), and the paper size (such as A4 or B4). Thus, the digital multi-function peripheral 1 of the present invention is capable of providing charged copying service for common users.

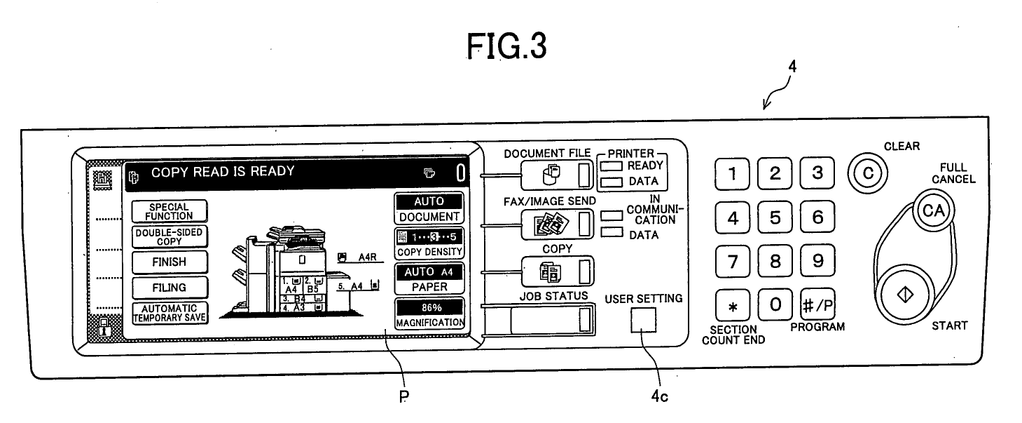

With reference to FIGS. 3 to 9, description will hereinafter be made of processing to set the time zones and the operation screens in an associated manner. This processing is carried out by the apparatus control portion 3 and the operation portion (the input portion 4a and the display portion 4b).

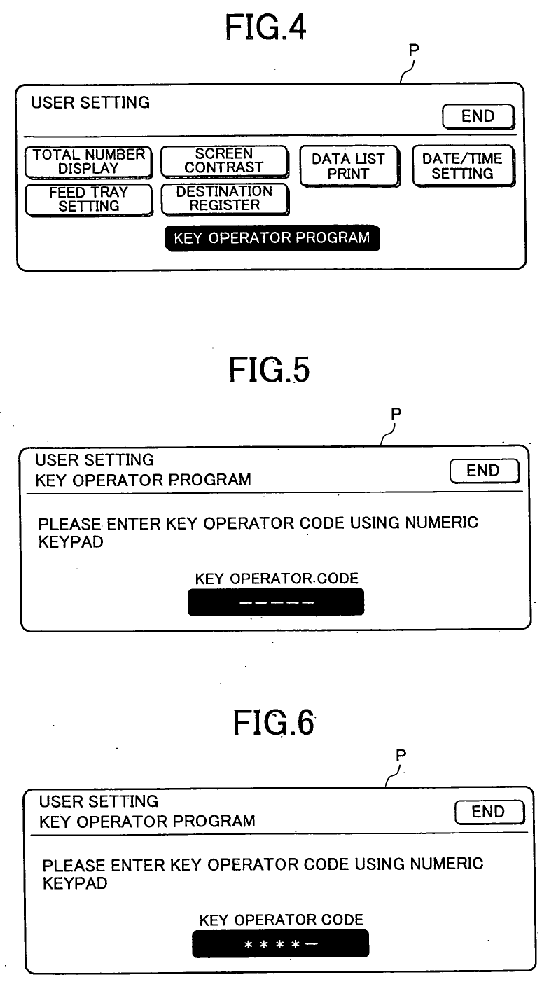

FIG. 3 depicts a configuration example of the operation portion 4 of the digital multi-function peripheral 1. Referring to FIG. 3, the operation portion 4 includes a touch panel P and a user setting button 4c. The touch panel P of FIG. 3 provides a display of the business-use operation screen. Various functions are assigned to the business-use operation screen that include “special function”, “double-sided copy”, “finish”, “filing”, and “automatic temporary retention”. The operator such as a system manager presses the user setting button 4c to set the business-use operation screen and the printing service operation screen in a manner associated with corresponding time zones to be displayed. Afterward, the setting screen transitions as shown in FIGS. 4 to 9.

FIG. 4 depicts an example of a user setting screen displayed on the touch panel P of the digital multi-function peripheral 1. The user setting screen includes, e.g., items such as “total number display”, “screen contrast”, “data list print”, “date/time setting”, “feed tray setting”, “destination register”, and “key operator program”. This example shows the state where the item “key operator program ” is selected.

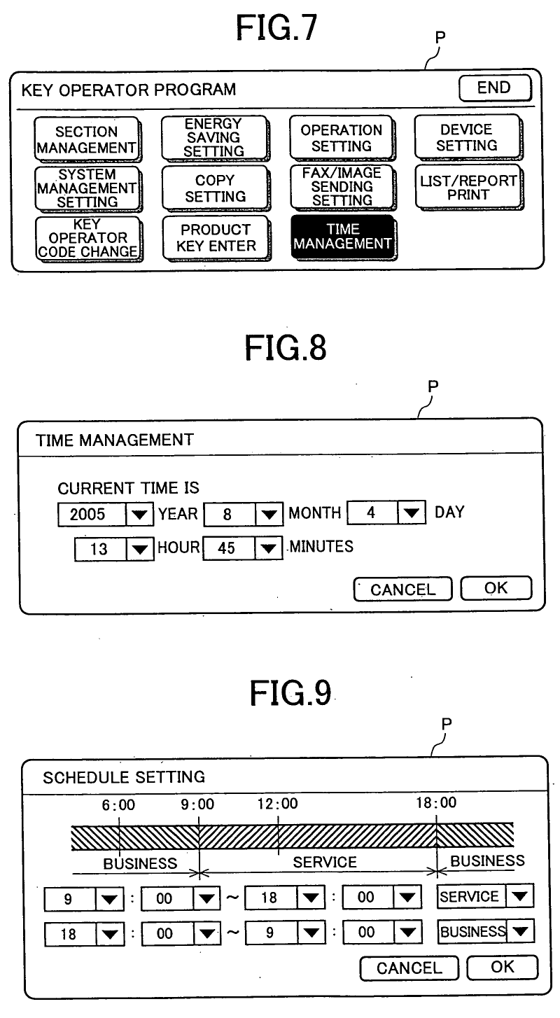

FIG. 5 depicts an example of an authentication information input screen for allowing a key operator program setting screen to appear on the touch panel P of the digital multi-function peripheral 1. FIG. 6 depicts another example of the authentication information input screen and depicts the state where the authentication information is input on the screen shown in FIG. 5. On the authentication information input screen of FIG. 5, the operator enters a key operator code that is authentication information using e.g., the numeric keypad of the digital multi-function peripheral 1. FIG. 6 shows the state where the key operator code is entered. When the authentication is accepted, the digital multi-function peripheral 1 displays a key operator program setting screen shown in FIG. 7 that will be described below.

FIG. 7 depicts an example of the key operator program screen appearing on the touch panel P of the digital multi-function peripheral 1. The key operator program screen includes, e.g., items such as “section management”, “energy saving setting”, “operation setting”, “device setting”, “system management setting”, “copy setting”, “fax/image sending setting”, “list/report print”, “key operator code change”, “product key enter”, and “time management”. This example shows the state where the item “time management” is selected. In this manner, the operator authenticated on the authentication information input screen of FIGS. 5 and 6 is allowed to perform various settings for the key operator program shown in FIG. 7.

FIG. 8 depicts an example of a time management screen appearing on the touch panel P of the digital multi-function peripheral 1. The time management screen is a screen for setting the date and time. If the date and time are correct, an “OK” button is pressed to shift to a schedule setting screen shown in FIG. 9. If the date and time are incorrect, “▾” is pressed to adjust to the correct date and time, after which the “OK” button is pressed to shift to the schedule setting screen.

FIG. 9 depicts an example of the schedule setting screen appearing on the touch panel P of the digital multi-function peripheral 1. The schedule setting screen is a screen for setting two different operation screens (for printing services and for business use in this example) in a manner associated with the time zones to display the corresponding operation screens. Setting of this example is such that the operation screen for printing services is displayed during the time zone of 09:00 to 18:00 hours and that the operation screen for business use is displayed during the time zone of 18:00 to 09:00 hours on the next day. If those details of setting are acceptable, the “OK” button is pressed to end the setting processing. As a result, in accordance with the above setting, the apparatus control portion 3 executes the printing service program once 09:00 hours arrive, to display the operation screen for printing services, and further executes the business-use program once 18:00 hours arrive, to perform processing to switch to the operation screen for business use.

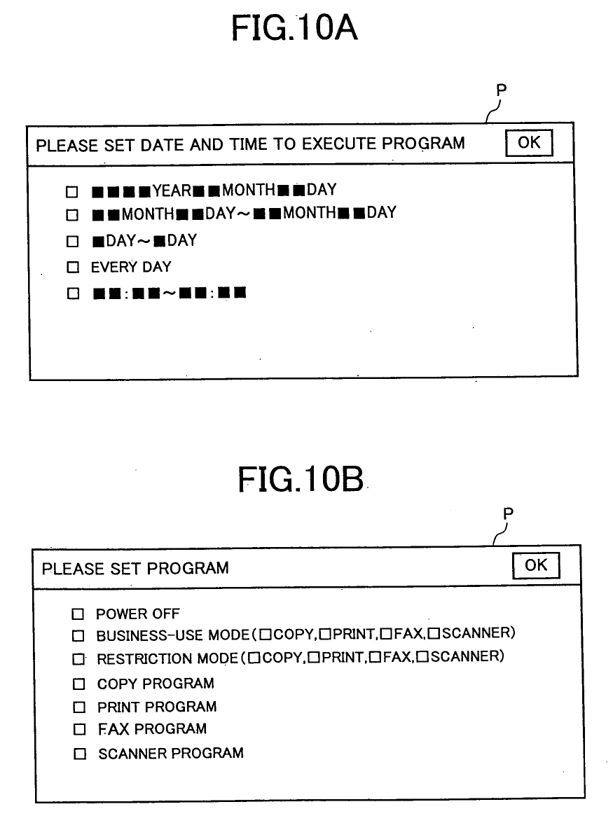

FIG. 10A depicts an example of a time setting screen appearing on the touch panel P of the digital multi-function peripheral 1 and FIG. 10B depicts an example of a program setting screen appearing on the touch panel P of the digital multi-function peripheral 1. The time setting screen of FIG. 10A is a screen for setting the date and time to execute the programs (such as the printing service program and the business-use program), enabling an execution date (e.g., 2005/10/01), an execution period (e.g., 10/01 to 10/10), execution days (e.g., Mon. to Fri.) or every day, an execution time zone (e.g., 09:00 to 18:00 hours), etc., to be set by checking check boxes (□).

The program setting screen of FIG. 10B is a screen for setting a program to be executed based on the details set in FIG. 10A. Checking check boxes (□) enables settings of e.g., a power off for turning off the power of the digital multi-function peripheral 1, a business-use mode for using the digital multi-function peripheral 1 as business use (further enabling setting of copy, print, FAX, and scanner), a restriction mode for imposing various restrictions on the functions for use (further enabling setting of copy, print, FAX, and scanner), a copy program for using the copier function, a print program for using the print function, a FAX program for using the FAX function, and a scanner program for using the scanner function.

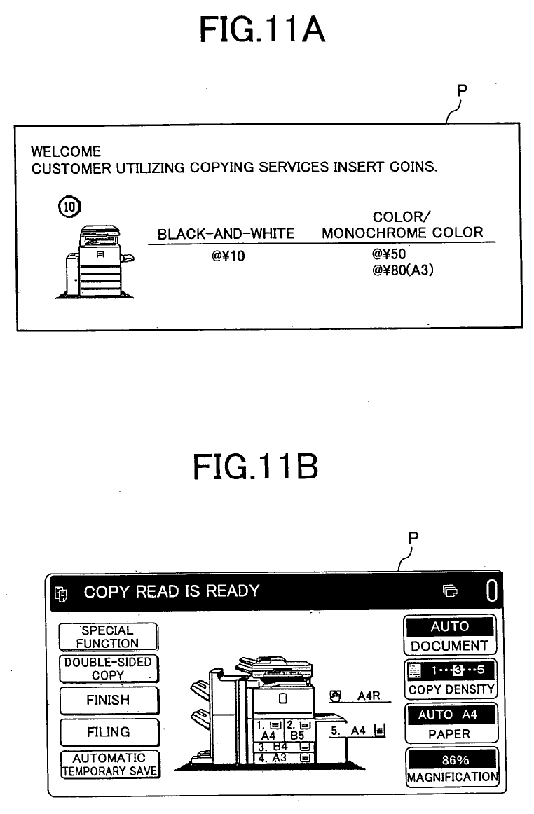

FIGS. 11A and 11B depict examples of the operation screen appearing on the touch panel P of the digital multi-function peripheral 1. The operation screen of FIG. 11A is an operation screen for printing services appearing during the time zone of daytime (e.g., 09:00 to 18:00 hours), providing a display of copy charge information, etc. The operation screen of FIG. 11B is an operation screen for business use appearing during the time zone of nighttime (e.g., 18:00 to 22:00 hours), providing a display of the same screen as the operation screen of FIG. 3 described above. In accordance with the details of the above settings, the apparatus control portion 3 executes the printing service program once 09:00 hours arrive to allow the printing service operation screen of FIG. 11A to appear, and further executes the business use program once 18:00 hours arrive to perform processing to switch to the business-use operation screen of FIG. 11B.

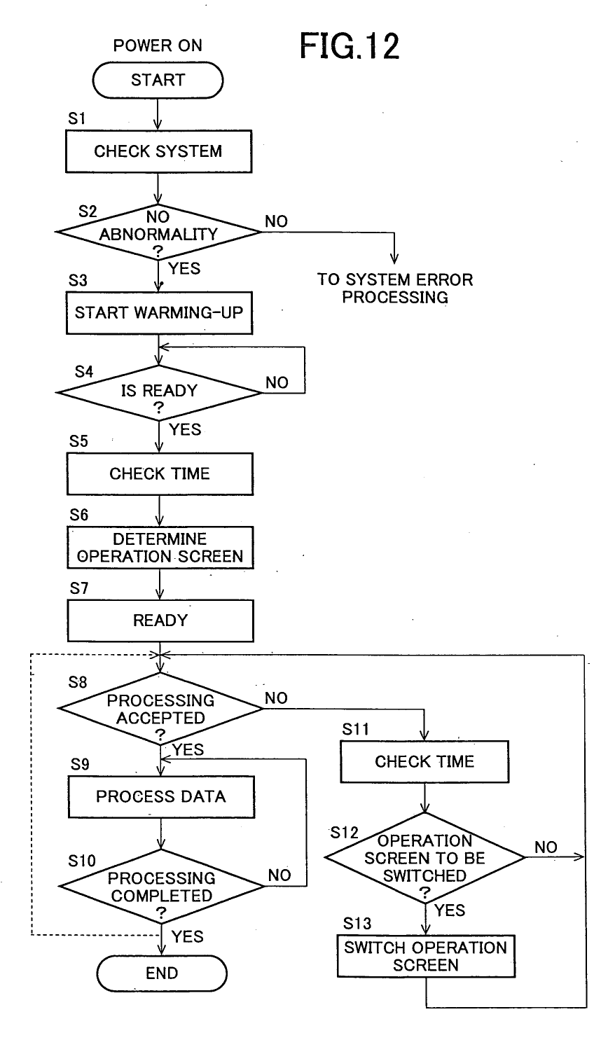

FIG. 12 is a flow diagram for explaining the flow of operation screen switching display processing effected by the digital multi-function peripheral 1 of the present invention. First, the digital multi-function peripheral 1 performs a system check (step S1) to determine whether the system has no abnormality (step S2), and if abnormality is present (case of NO), shifts to a system error process. If abnormality is absent at step S2 (case of YES), the digital multi-function peripheral 1 starts warming-up (step S3) to determine whether it is ready (step S4), and if affirmative, that is, it is ready (case of YES), checks the current time (step S5). If negative, that is, it is not ready (case of NO) at step S4, then the processing at step S4 is repeated.

Based on the time checked at step S5, the digital multi-function peripheral 1 determines an operation screen (for printing services or business-use in this example) to be displayed (step S6), shifting to the ready mode for entry of data processing such as copying (step S7). The digital multi-function peripheral 1 determines whether it has accepted the data processing (step S8), and if affirmative (case of YES), executes the data processing (step S9) to determine whether it has completed the data processing (step S10), and if negative (case of NO), returns to step S9 for repetition of the processing. If affirmative (case of YES) at step S10, then control intactly comes to an end or returns to step S8, shifting to standby mode for acceptance of data processing.

If the digital multi-function peripheral 1 does not accept the data processing at step S8 (case of NO), then it performs a time check (step S11), and based on the result, determines whether the operation screen is to be switched (step S12). If affirmative, that is, it is determined that the operation screen is to be switched (case of YES), the digital multi-function peripheral 1 switches the operation screen (step S13) and returns to step S8, shifting to the standby mode for acceptance of data processing. If, at step S12, it is determined that the operation screen needs not to be switched (case of NO), the digital multi-function peripheral 1 returns to step S8, shifting to the standby mode for acceptance of data processing.

Since the timer 17 of the digital multi-function peripheral 1 is operating at all times at step S11, the apparatus control portion 3 may see the timer 17 at all times or every given time to check the time. Alternatively, the timer 17 may inform the apparatus control portion 3 of arrival at the switching hour.

When the time to switch the operation screen arrives in the course of data processing, the operation screen is to be switched after the completion of a series of data processes so that the data processing is not interrupted halfway. Although the operation screen switching processing is automatically carried out depending on the time (time zone), manual switching may be done by the system manager, etc. if necessary.

As described above, according to the present invention, the image forming apparatus forming images from image data entered is capable of switchingly displaying at least two different operation screens depending on the time (time zone), thereby eliminating the need for the user to switch the operation screens each.time depending on forms of use, as well as making problems such as customizing the operation screens unnecessary.

1. An image forming apparatus forming images from image data entered, comprising:
a display portion that displays switchably at least two different operation screens;
a timer that measures a time; and
a control portion that controls switching to one of the at least two different operation screens depending on the time.

2. The image forming apparatus as defined in claim 1, wherein the at least two different operation screens are respectively set for corresponding modes that depend on forms of use of the image forming apparatus so that functions corresponding to the modes are respectively assigned to the at least two different operation screens.

3. The image forming apparatus as defined in claim 2, accumulating a first program for displaying one of the at least two different operation screens, and a second program for displaying the other thereof, wherein the control portion reads either the first program or the second program for execution depending on the time.

4. The image forming apparatus as defined in claim 2 or 3, wherein the functions include one or more of a copier function, a printer function, a scanner function, and a facsimile function.

5. The image forming apparatus as defined in claim 2 or 3, wherein the modes include a printing service mode for providing printing services to charge for the services, and a business-use mode for use in general business.

6. The image forming apparatus as defined in claim 2 or 3, wherein the operation screen is comprised of a touch panel capable of entering coordinate positions of input regions on the operation screen.

7. The image forming apparatus as defined in claim 1, wherein the at least two different operation screens and the time zones to display the operation screens are set in an associated manner, and wherein the control portion switches to one of the at least two different operation screens depending on the settings.
